(19) United States
(12) Patent Application Publication
(10) Pub. No.: US 2025/0148270 A1
(43) Pub. Date: May 8, 2025

(54) TRAINING METHOD OF MULTI-TASK INTEGRATED DEEP LEARNING MODEL

(71) Applicant: Korea Electronics Technology Institute, Seongnam-si (KR)

(72) Inventors: Choong Sang CHO, Seongnam-si (KR); Gui Sik KIM, Seongnam-si (KR); Ju Hong YOON, Hwaseong-si (KR); Young Han LEE, Seongnam-si (KR)

(73) Assignee: Korea Electronics Technology Institute, Seongnam-si (KR)

(21) Appl. No.: 18/644,636

(22) Filed: Apr. 24, 2024

(30) Foreign Application Priority Data
Nov. 8, 2023 (KR) 10-2023-0153181

(51) Int. Cl. G06N 3/0475

(52) U.S. Cl. CPC G06N 3/0475

(57) ABSTRACT

There is provided a training method of a multi-task integrated deep learning model. A multi-task integrated deep learning model training method according to an embodiment may generate training data for a plurality of visual intelligence tasks from visual data in a batch, and may train a multi-task integrated deep learning model which performs a plurality of visual intelligence tasks by using the generated training data. Accordingly, training data for training an integrated deep learning model which performs various visual intelligence tasks is generated in a batch through multi-data conversion kernels, so that appropriate training data for performing multiple tasks may be easily obtained and effective training of a multi-task integrated deep learning model is possible.

### CROSS-REFERENCE TO RELATED APPLICATION(S) AND CLAIM OF PRIORITY

This application is based on and claims priority under 35 U.S.C. § 119 to Korean Patent Application No. 10-2023-0153181, filed on Nov. 8, 2023, in the Korean Intellectual Property Office, the disclosure of which is herein incorporated by reference in its entirety.

### BACKGROUND

### Field

The disclosure relates to training of a deep learning model, and more particularly, to a method for training an integrated deep learning model for performing various visual intelligence tasks.

### Description of Related Art

Typically, a deep learning model may be designed and trained to be appropriate for a single task. For example, a deep learning model for performing dehazing and a deep learning model for performing denoising may be designed and trained as individual models, respectively.

Configuring deep learning models according to tasks may require many storage spaces due to the increase in the number of models, and an interest in a multi-task integrated deep learning model for performing various tasks is increasing.

However, a multi-task integrated deep learning model may have difficulty in learning since it should learn multiple tasks rather than a specific task, and in particular, there is a problem that it is difficult to acquire training data appropriate for performing multiple tasks.

### SUMMARY

The disclosure has been developed in order to solve the above-described problems, and an object of the disclosure is to provide a multi-task integrated deep learning model training method which generates training data for training an integrated deep learning model, which performs various visual intelligence tasks, in a batch through multi-data conversion kernels.

To achieve the above-described object, a deep learning model training method according to an embodiment may include: obtaining visual data; generating training data for a plurality of visual intelligence tasks from the obtained visual data in a batch; and training a multi-task integrated deep learning model which performs a plurality of visual intelligence tasks by using the generated training data.

Generating may include generating visual data from the obtained visual data through corresponding kernels, respectively, before corresponding visual intelligence tasks are performed, and thereby generating input data of the multi-task integrated deep learning model, and the obtained visual data may be labeled data regarding the input data.

Labeled data regarding the input data obtained from one piece of visual data may be all the same. The visual intelligence tasks may be selectable by a user. Obtaining, generating, and training may be repeated for visual data obtained in a same domain.

A size of input data and a size of output data of the multi-task integrated deep learning model may be the same. The visual intelligence tasks may include dehazing, super-resolution, denoising, inpainting, high dynamic range (HDR), colorization.

The kernels used in generating the training data may include: a dehazing data conversion kernel configured to generate input data of the multi-task integrated deep learning model by adding a haze to visual data; a super-resolution data conversion kernel configured to generate input data of the multi-task integrated deep learning model by converting visual data into data of a low resolution; a denoising data conversion kernel configured to generate input data of the multi-task integrated deep learning model by adding a noise to visual data; an inpainting data conversion kernel configured to generate input data of the multi-task integrated deep learning model by masking a specific region in visual data; a HDR data conversion kernel configured to generate input data of the multi-task integrated deep learning model by converting visual data into data of a low illuminance; and a colorization data conversion kernel configured to generate input data of the multi-task integrated deep learning model by converting visual data into a gray image.

Training may include training the multi-task integrated deep learning model by using a weighted sum of a loss obtained considering characteristics of the multi-task integrated deep learning model and a common loss of the multiple visual intelligence tasks through a loss function.

According to another aspect of the disclosure, there is provided a deep learning model training system including: a first storage unit configured to store obtained visual data; a data conversion unit configured to generate training data for a plurality of visual intelligence tasks in a batch from visual data stored in the first storage unit; a second storage unit configured to store the generated training data; and a training unit configured to train a multi-task integrated deep learning model which performs a plurality of visual intelligence tasks by using the training data stored in the second storage unit.

According to still another aspect of the disclosure, there is provided a deep learning model training method including: generating training data for a plurality of visual intelligence tasks from visual data in a batch; and training a multi-task integrated deep learning model which performs a plurality of visual intelligence tasks by using the generated training data.

According to yet another aspect of the disclosure, there is provided a deep learning model training system including: a data conversion unit configured to generate training data for a plurality of visual intelligence tasks from visual data in a batch; and a training unit configured to train a multi-task integrated deep learning model which performs a plurality of visual intelligence tasks by using the generated training data.

As described above, according to embodiments of the disclosure, training data for training an integrated deep learning model which performs various visual intelligence tasks is generated in a batch through multi-data conversion kernels, so that appropriate training data for performing multiple tasks may be easily obtained and effective training of a multi-task integrated deep learning model is possible.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a view illustrating a multi-task integrated deep learning model training system according to an embodiment of the disclosure;

FIG. 2 is a view illustrating examples of a visual intelligence task performed by a multi-task integrated deep learning model, and selection thereof;

FIG. 3 is a view illustrating a data conversion kernel configuration and an example of generation of training data; and

FIG. 4 is a view illustrating an example of a result of performing tasks by a multi-task integrated deep learning model which learns multiple visual intelligence tasks with respect to a satellite image domain.

### DETAILED DESCRIPTION

Hereinafter, the disclosure will be described in more detail with reference to the accompanying drawings.

Embodiments of the disclosure provide a training method of a multi-task integrated deep learning model. The disclosure relates to a technology for training a single deep learning model to learn various visual intelligence tasks having high similarity, which are required in a domain, such as autonomous driving, image security, satellite image, robot vision, etc.

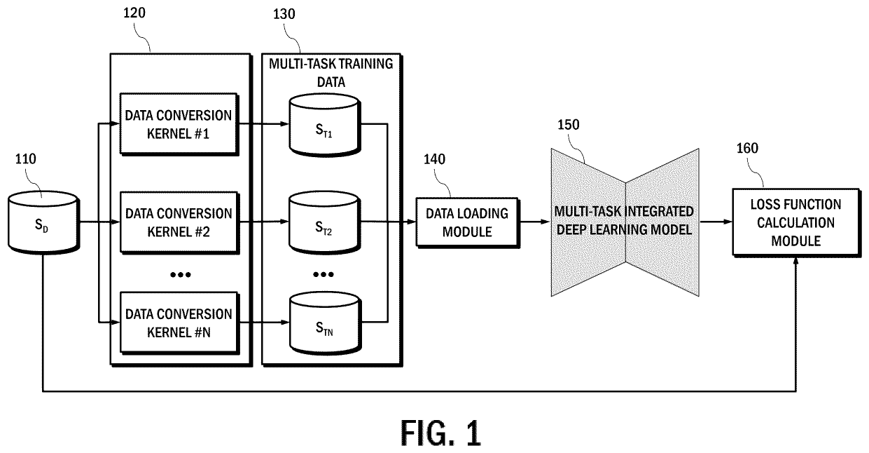

FIG. 1 is a view illustrating a configuration of a multi-task integrated deep learning model training system according to an embodiment of the disclosure. As shown in FIG. 1, the training system according to an embodiment may include a visual data repository 110, data conversion kernels 120, a multi-task training data repository 130, a data loading module 140, a multi-task integrated deep learning model 150, and a loss function calculation module 160.

The visual data repository 110 may be a repository in which visual data SD obtained in a specific domain (for example, an autonomous vehicle, a satellite, or a camera) is stored.

The data conversion kernels 120 may generate training data S_{T1}, S_{T2}, . . . , S_{TN} for a plurality of visual intelligence tasks T₁, T₂, . . . , T_{N} from visual data stored in the visual data repository 110, and may store the training data in the multi-task training data repository 130.

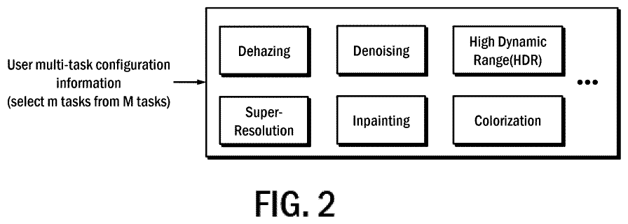

FIG. 2 illustrates visual intelligence tasks performed by the multi-task integrated deep learning model 150, including 1) dehazing, 2) super-resolution, 3) denoising, 4) inpainting, 5) high dynamic range (HDR), 6) colorization. As shown in the drawing, only some of the visual intelligence tasks may be selected by a user to be performed by the multi-task integrated deep learning model 150.

The data conversion kernels 120 may be provided for respective visual intelligence tasks. When all of the visual intelligence tasks shown in FIG. 2 is the visual intelligence tasks that the multi-task integrated deep learning model 150 will learn or perform, the data conversion kernels 120 should include 1) a dehazing data conversion kernel, 2) a super-resolution data conversion kernel, 3) a denoising data conversion kernel, 4) an inpainting data conversion kernel, 5) a HDR data conversion kernel, and 6) a colorization data conversion kernel.

1) The dehazing data conversion kernel may be a kernel that generates training data S_{T1} of the multi-task training data repository 130 by adding a haze to visual data S_{D} of the visual data repository 110.

2) The super-resolution data conversion kernel may be a kernel that generates training data S_{T2} of the multi-task training data repository 130 by converting visual data S_{D} of the visual data repository 110 into data of a low resolution.

3) The denoising data conversion kernel may be a kernel that generates training data S_{T3} of the multi-task training data repository 130 by adding a noise to visual data S_{D} of the visual data repository 110.

4) The inpainting data conversion kernel may be a kernel that generates training data S_{T4} of the multi-task training data repository 130 by masking a specific region in visual data S_{D} of the visual data repository 110.

5) The HDR data conversion kernel may be a kernel that generates training data S_{T5} of the multi-task training data repository 130 by converting visual data S_{D} of the visual data repository 110 into data of a low illuminance.

6) The colorization data conversion kernel may be a kernel that generates training data S_{T6} of the multi-task training data repository 130 by converting visual data S_{D} of the visual data repository 110 into a gray image.

Training data S_{T1} may be generated from visual data S_{D} by a kernel [Kᵢ( )] corresponding to a visual intelligence task selected from all of the selectable visual intelligence tasks T₁, T₂, . . . , T_{N} based on the following equation:

$${S}_{T i} = {K}_{i} ( {S}_{D} )$$

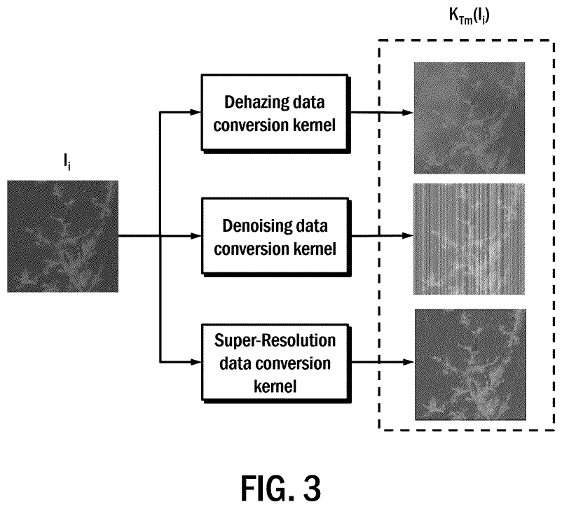

Meanwhile, FIG. 3 illustrates configurations of data conversion kernels and an example of a result of generating training data (S_{Ti}=Kᵢ(Iᵢ)) by conversion kernels from visual data Iᵢ when dehazing, denoising, super-resolution are selected as visual intelligence tasks.

In this example, visual data may be generated through corresponding data conversion kernels 120 from visual data (S_{D}=Iᵢ) stored in the visual data repository 110 before corresponding visual intelligence tasks are performed, such that input data of the multi-task integrated deep learning model 150 may be generated. Meanwhile, labeled data regarding the generated input data S_{Ti} may be visual data S_{D} which is stored in the visual data repository 110.

Accordingly, labeled data regarding the input data S_{Ti} of the multi-task integrated deep learning model 150, which is obtained from one piece of visual data S_{D}, may be visual data S_{D} which is a basis for generating the input data S_{Ti}, and may be all the same.

Generating training data S_{T1}, S_{T2}, . . . , S_{TN} by the data conversion kernels 120 may be repeated for all of the visual data S_{D} which is stored in the visual data repository 110 and is obtained in the same domain. Accordingly, when the number of pieces of visual data S_{D} stored in the visual data repository 110 is M, MXN pieces of training data may be generated and may be stored in the multi-task training data repository 130.

The multi-task integrated deep learning model 150 may be a deep learning model that performs a plurality of visual intelligence tasks T₁, T₂, . . . , T_{N}. The multi-task integrated deep learning model 150 may be designed such that the size of input data and the size of output data are the same.

There is no limit to the type and structure of the multi-task integrated deep learning model 150. Accordingly, the multi-task integrated deep learning model 150 may be implemented by a variational auto encoder (VAE), a U-net, a diffusion model, or other models.

The data loading module 140 and the loss function calculation module 160 may be configured to train the multi-task integrated deep learning model 150.

The data loading module 140 may constitute a training data set which includes training data [S_{T1}, S_{T2}, . . . , S_{TN}, output data Kᵢ(Iᵢ) of the data conversion kernel 120] stored in the multi-task training data repository 130 as input data to the multi-task integrated deep learning model 150, and visual data [S_{D}, input data Iᵢ of the data conversion kernel 120] stored in the visual data repository 110 as labeled data. The training data set may be expressed by the following equation:

$$\{ ( {I}_{i} , {K}_{{T}_{m}} ( {I}_{i} ) ) \vert i = 1 ∼ N , m = 1 ∼ M \}$$

where N is the number of pieces of visual data Ii, M is the total number of visual intelligence tasks, and m is the number of selected visual intelligence tasks.

The loss function calculation module 160 may perform calculation with respect to training data for the multi-task integrated deep learning model 150, and may train the multi-task integrated deep learning model 150 through backpropagation. The loss function may be configured by the following equation:

$$L = α \times {L}_{m} + ( 1 - α ) \times {L}_{T g}$$

where Lm is a loss obtained considering characteristics of the multi-task integrated deep learning model 150, and is a generative adversarial networks loss when a GAN-based diffusion model is used as the multi-task integrated deep learning model 150. L_{Tg} is a common loss of the multiple visual intelligence tasks and is a sum of pixel losses. α is a weight value and has a value between 0 and 1.

Up to now, a training method of a multi-task integrated deep learning model has been described with reference to preferred embodiments.

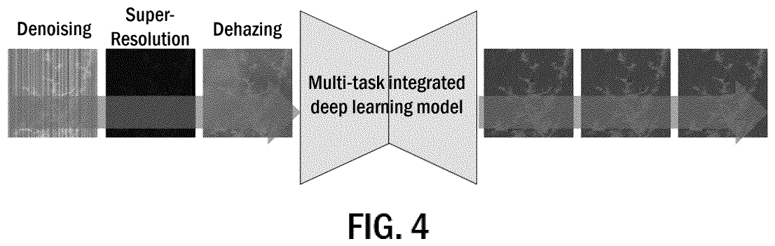

FIG. 4 illustrates an example of a result of performing corresponding visual intelligence tasks with respect to inputted visual data and outputting by the multi-task integrated deep learning model 150 which learns multi-visual intelligence tasks (dehazing, denoising, super-resolution) with respect to a satellite image domain.

In an embodiment, training data for training an integrated deep learning model which performs various visual intelligence tasks is generated in a batch through multi-data conversion kernels, so that appropriate training data for performing multiple tasks may be easily obtained and effective training of a multi-task integrated deep learning model is possible.

The technical concept of the disclosure may be applied to a computer-readable recording medium which records a computer program for performing the functions of the apparatus and the method according to the present embodiments. In addition, the technical idea according to various embodiments of the disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the present disclosure have been illustrated and described, the present disclosure is not limited to the above-described specific embodiments. Various changes can be made by a person skilled in the at without departing from the scope of the present disclosure claimed in claims, and also, changed embodiments should not be understood as being separate from the technical idea or prospect of the present disclosure.

What is claimed is:

1. A deep learning model training method comprising:
obtaining visual data;
generating training data for a plurality of visual intelligence tasks from the obtained visual data in a batch; and
training a multi-task integrated deep learning model which performs a plurality of visual intelligence tasks by using the generated training data.

2. The deep learning model training method of claim 1, wherein generating comprises generating visual data from the obtained visual data through corresponding kernels, respectively, before corresponding visual intelligence tasks are performed, and thereby generating input data of the multi-task integrated deep learning model, and
wherein the obtained visual data is labeled data regarding the input data.

3. The deep learning model training method of claim 2, wherein labeled data regarding the input data obtained from one piece of visual data is all the same.

4. The deep learning model training method of claim 2, wherein the visual intelligence tasks are selectable by a user.

5. The deep learning model training method of claim 2, wherein obtaining, generating, and training are repeated for visual data obtained in a same domain.

6. The deep learning model training method of claim 2, wherein a size of input data and a size of output data of the multi-task integrated deep learning model are the same.

7. The deep learning model training method of claim 6, wherein the visual intelligence tasks comprise dehazing, super-resolution, denoising, inpainting, high dynamic range (HDR), colorization.

8. The deep learning model training method of claim 6, wherein the kernels used in generating the training data comprises:
a dehazing data conversion kernel configured to generate input data of the multi-task integrated deep learning model by adding a haze to visual data;
a super-resolution data conversion kernel configured to generate input data of the multi-task integrated deep learning model by converting visual data into data of a low resolution;
a denoising data conversion kernel configured to generate input data of the multi-task integrated deep learning model by adding a noise to visual data;
an inpainting data conversion kernel configured to generate input data of the multi-task integrated deep learning model by masking a specific region in visual data;
a HDR data conversion kernel configured to generate input data of the multi-task integrated deep learning model by converting visual data into data of a low illuminance; and
a colorization data conversion kernel configured to generate input data of the multi-task integrated deep learning model by converting visual data into a gray image.

9. The deep learning model training method of claim 1, wherein training comprises training the multi-task integrated deep learning model by using a weighted sum of a loss obtained considering characteristics of the multi-task integrated deep learning model and a common loss of the multiple visual intelligence tasks through a loss function.

10. A deep learning model training system comprising:
a first storage unit configured to store obtained visual data;
a data conversion unit configured to generate training data for a plurality of visual intelligence tasks in a batch from visual data stored in the first storage unit;
a second storage unit configured to store the generated training data; and
a training unit configured to train a multi-task integrated deep learning model which performs a plurality of visual intelligence tasks by using the training data stored in the second storage unit.

11. A deep learning model training method comprising:
generating training data for a plurality of visual intelligence tasks from visual data in a batch; and
training a multi-task integrated deep learning model which performs a plurality of visual intelligence tasks by using the generated training data.
